(19) United States
(12) Patent Application Publication
(10) Pub. No.: US 2012/0059997 A1
(43) Pub. Date: Mar. 8, 2012

(54) APPARATUS AND METHOD FOR DETECTING DATA RACE

(76) Inventors: Dae-Hyun CHO, Suwon-si (KR); Sung-Do Moon, Seongnam-si (KR)

(21) Appl. No.: 13/172,667

(22) Filed: Jun. 29, 2011

(30) Foreign Application Priority Data
Sep. 2, 2010 (KR) 10-2010-0086076

(51) Int. Cl. G06F 12/00

(52) U.S. Cl. 711/150; 711/E12.001

(57) ABSTRACT

An apparatus and method for detecting a data race of a multithread system is provided. A thread may be divided into an open sub region or a closed sub region according to a vector clock and an execution state. In order to detect a data race before the execution is terminated, when an open sub region is converted to a closed sub region, a memory access event corresponding to the closed sub region is investigated and a memory access event having no parallel relation with an open sub region is deleted among memory access events having been subject to the investigation.

### CROSS-REFERENCE TO RELATED APPLICATION

This application claims the benefit under 35 U.S.C. §119(a) of Korean Patent Application No. 10-2010-0086076, filed on Sep. 2, 2010, the disclosure of which is incorporated by reference in its entirety for all purposes.

### FIELD

The following disclosure relates to detecting a data race in a multi-thread computing system.

### BACKGROUND

A multi-thread application is important for enhancing the efficiency in use of multi-core systems. As known in the art, a “thread” is the smallest unit of processing that can be scheduled for execution by an operating system. When writing multi-thread applications, many developers face concurrency errors such as data-race and deadlock that ordinarily do not occur in single thread applications.

A data race condition may be considered a “bug” that occurs when the outcome of a program depends on which of two or more threads reaches a particular block of code first.

Running a program many times may produce different results, and thus the result of any given run cannot be predicted. A deadlock occurs when a thread tries to lock a resource that another thread has already locked. As such, no thread can make any further progress.

In order to resolve such concurrency errors, tools such as an error checker have been developed.

A basic tool for synchronization is formed as a thread-related system function, and thus extraction and retention of an event of the basis tool may take relatively small time and require low costs in terms of memory use. However, the extraction and retention of a memory access event may take significant time and incur significant costs in term of memory use. In order to detect a data race, a great amount of additional information is required for each memory access. In addition to information about memory address and size, the data race detection requires information representing which thread accesses, and which of a read operation and a write operation is performed, and at least one of a lock-set and a vector-clock depending on a detection scheme.

In general, in order to improve cache locality when a memory access event is stored, memory access events are kept for respective threads and subject to comparative analysis among the threads. Accordingly, the memory access events need to be maintained until the analysis for detection is performed. Maintaining memory access events may be implemented in various forms in terms of data structure and storage scheme. In most cases, a data race detection tool stores events until the termination of a program and perform the analysis for detection and reports the detection result.

However, the memory costs needed in maintaining the memory access event by use of such a data race detection method may be so large that an apparatus having a memory limitation has a difficulty in running the data race detection. In addition, even in a case of an apparatus having a small memory limitation, if the running time of an application is large, the memory cost may be significantly great to cause problems and also it takes a long time to check the detection result.

### SUMMARY

In one aspect, an apparatus for detecting a data race in a computing system may include: a dividing unit configured to divide a thread into at least one sub region according to a vector clock; an investigation unit configured to investigate memory access events that correspond to the at least one sub region, respectively, to detect a data race before an execution of the thread is terminated; and a deleting unit configured to delete a memory access event having no need for retention among the memory access events having been subject to the investigation.

In another aspect, a method of detecting a data race in a computing system may include: dividing a thread into at least one sub region according to a vector clock; investigating memory access events that correspond to the at least one sub region, respectively, to detect a data race before an execution of the thread is terminated; and deleting a memory access event having no need for retention among the memory access events having been subject to the investigation.

In yet another aspect, a computer-readable medium having computer-executable instructions may be configured to execute a method of detecting a data race in a computing system. The instructions may be configured to divide a thread into at least one sub region according to a vector clock; investigate memory access events that correspond to the at least one sub region, respectively, to detect a data race before an execution of the thread is terminated; and delete a memory access event having no need for retention among the memory access events having been subject to the investigation.

The sub region may include a closed sub region having been subject to execution and an open region not having been execution.

The investigating of memory access events may be initiated when a predetermined open sub region is converted into a closed sub region.

An investigation object to be investigated may be a memory access event of a sub region which is closed before the initiation of the investigation.

A deletion object may be a memory access event corresponding to a closed sub region having no parallel relationship with an open sub region among investigation objects.

Other aspects and features will become apparent to those skilled in the art from the following detailed description, which, taken in conjunction with the attached drawings, discloses various embodiments.

### BRIEF DESCRIPTION OF THE DRAWINGS

FIG. 1 shows an apparatus for detecting a data race.

FIG. 2 shows a vector clock used with the data race detecting apparatus.

FIGS. 3A to 3D show operations of the data race detecting apparatus.

FIG. 4 shows a method of detecting data race using the data race detecting apparatus.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, various embodiments will be described with reference to accompanying drawings in detail.

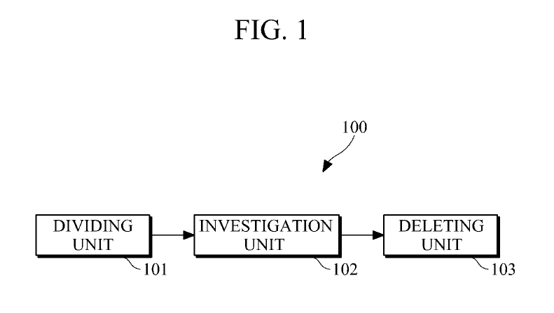

FIG. 1 shows an apparatus for detecting data race. A data race detecting apparatus 100 may configured to detect a data race which occurs when different threads of a multi thread program access the same memory region or the same memory resource. The data race is one representative example of concurrence errors of the multi thread program and may be referred to as a data race condition or a race condition. One or more concurrence errors may be similarly handled as a data race according to various embodiments.

The data race detecting apparatus 100 may be applied to a single core system or a multi core system which concurrently processes different threads. For example, a single core system may concurrently process multiple threads in a time sharing scheme. And a multi core system may process multiple threads in a parallel scheme through independent cores, for instance.

The data race detecting apparatus 100 may be configured to receive a memory access event from a thread and analyzes the received memory access event, thereby detecting a data race. The memory access event may represent memory access information of a thread. The memory access event may include, for instance, information on which thread has accessed a memory, information indicating the address of an accessed memory region, information indicating the size of an accessed memory region, information indicating whether the access is for read operation or a write operation, and information indicating a vector clock of each thread. For example, according to a result of analysis of the memory access event where different threads access the same memory region, the data race detecting apparatus 100 determines that a data race occurs. The report on a memory access event may be achieved, for instance, by an instrumentation code that is inserted into a source code and/or an execution code of the thread.

The data race detecting apparatus 100 may be configured to investigate memory access events in the middle of execution of a thread, and to delete a memory access event having no need for retention among the memory access events having been subject to the investigation. For instance, the data race detecting apparatus 100 may delete a memory access event that is not to be used for investigating a data race any longer, thereby reducing memory use.

As shown, the data race detecting apparatus 100 may include a dividing unit 101, an investigation unit 102 and a deleting unit 103.

The dividing unit 101 may be configured to continuously divide one or more threads into a closed sub area or an open sub region based on a vector clock and an execution state. A sub region represents a portion of a thread region using an identical vector clock. The vector clock may be a message passed among different environments in a distributed environment such that a happens-before relationship of the environments is determined. As used herein, a “happens-before relationship” is a means of ordering events based on the potential causal relationship of pairs of events in a concurrent system. For instance, this relationship may ensure that when memory writes one specific statement, it is visible to another specific statement.

The closed sub region represents a sub region having been subject to execution. An open sub region represents a region having not been subject to execution, that is, a region being executed. Accordingly, the thread may be divided into one or more closed sub regions and/or one or more open sub regions by the dividing unit 101. In addition, an open sub region may be converted into a closed sub region according to its execution state.

The investigation unit 102 may be configured to investigate memory access events that correspond to the sub areas, respectively, to detect a data race before an execution of the thread is terminated.

In relation to an investigation point of the investigation unit 102, the investigation unit 102 may be configured to investigate the memory access event before the execution of the thread is terminated, that is, while the thread is being executed. For example, the investigation unit 102 may initiate the investigation when a predetermined open sub region is converted into a closed sub region. The point when a predetermined open sub region is converted into a closed sub region is given as an example of the initiation point of investigation to avoid redundant investigation and reduce memory use. The investigation point is not limited as described herein and it will be appreciated that the investigation may be initiated at other points as long as the thread is being executed. In addition, if an object, which is to be subject to investigation in a midterm investigation, is limited to the memory access of a closed sub region, the data race detection may be simultaneously performed together with the execution of an original program.

In relation to an investigation object to be subject to investigation by the investigation unit 102, the investigation unit 102 may be configured to investigate memory access events of respective sub regions such that a data race is detected. Similar to the investigation point, it may be possible for the investigation to be performed on memory access events of all sub regions but preferably the investigation may be performed only on memory access events of sub regions having a closed state before the investigation point, thereby avoiding redundant investigation.

The deleting unit 103 may be configured to delete a memory access event having no need for retention among the memory access events having been subject to the investigation. In relation to a deletion object to be deleted, the deleting unit 103 may delete a part or all of the investigation objects having been subject to the investigation. For example, the deleting unit 103 may delete a memory access event corresponding to a closed sub region which has no parallel relationship with an open sub area among the memory access events having been subject to the investigation. The parallel relationship may be determined based on the vector clock for each sub region. Since the deletion object corresponds to a sub region that has no parallel relationship with an open sub region or a sub region to be open, the memory access by the sub region corresponding to the deletion object does not cause a data race with a memory access of the open sub region and the sub region to be open. Accordingly, the memory access by the corresponding sub region may not need to be subject to a following investigation, and may be deleted after the midterm investigation.

In one embodiment, a thread may be divided into one or more sub-regions depending on a vector clock, a data race is detected in sub region units while a thread is being executed and a memory access event of a sub region having no need for retention is deleted. Accordingly, the memory requirements (cost) may be reduced and the data race may be detected in an early stage.

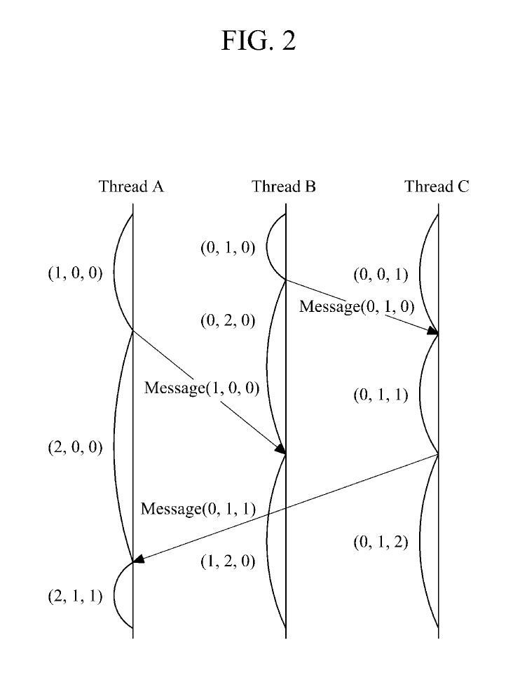

FIG. 2 shows a vector clock used with the data race detecting apparatus 100 of FIG. 1.

The vector clock schematic illustration in FIG. 2 represents a message passed among environments in a distributed environment such that a happens-before relationship of the environments may be determined. In a multi thread application, the vector clock may be exchanged in the form of a message in response to an instruction of a thread synchronization described below, for instance. In the case of a thread fork, a vector clock message may be sent from a parent thread to a child thread. In the case of a thread join, a vector clock message may be sent from a child thread to a parent thread. In the case of a thread barrier, the vector clock message may be exchanged among all threads corresponding to the barrier. In addition, if a thread releases a lock and another thread acquires the lock, a vector clock message may be sent from the thread having released the lock to the thread having acquired the lock. However, such a vector clock transfer and adjustment through the lock release/acquisition may not be used in a race detection method using a concept of a lock set. The thread having sent a vector clock message increments a clock value corresponding to its own dimension in the vector clock and the thread having received the vector clock message updates the clock value of its vector clock by taking the maximum of the clock value in its own vector clock and the clock value in the received message.

For example, when three threads including Thread A, Thread B and Thread C are executed at the same time, each thread may exchange a vector clock in a three dimensional message. When a jump is made from Thread A to Thread B, Thread A sends its vector clock (1, 0, 0) to Thread B. Thread B modifies its clock value from (0, 2, 0) to (1, 2, 0) using the received vector clock of the Thread A. Meanwhile, Thread A increments the vector clock from (1, 0, 0) to (2, 0, 0).

The vector clock for each thread may be used as data to determine the happens-before relationship among threads. Vector clocks of two predetermined threads may be referred to as X and Y, respectively. A comparison of the vector clocks of the threads may be compared. For instance X may be compared with Y for each dimension of the vector clock. And if each clock value of X is less than or equal to each clock value of Y in all dimensions, it is determined that the execution of the thread having the vector clock X is prior to the execution of the thread having the vector clock Y. When the vector clocks of two predetermined threads are investigated, and it is determined that a happens-before relationship does not exist, the two threads may be in a parallel relationship. In addition, if the two threads are in a parallel relationship, a data race may occur.

For example, consider when a first vector clock (1, 0, 0) of Thread A is compared with a third vector clock (1, 2, 0) of Thread B. Since each clock value of the first vector clock (1, 0, 0) is less than or equal to each clock value of the third vector clock (1, 2, 0) in all dimensions, a happens-before relationship exists. Meanwhile, consider when a second vector clock (2, 0, 0) of Thread A is compared with a third vector clock (0, 1, 2) of Thread C. Since each clock value of (2, 0, 0) is not less than or equal to each clock value of (0, 1, 2) in all dimensions, a happens-before relationship does not exist and thus it is determined that Thread A and Thread C are in a parallel relationship.

According to an embodiment, a sub region of a thread may be defined as a portion having an identical vector clock. For example, Thread A may be divided into a first sub region corresponding to a vector clock (1, 0, 0), a second sub region corresponding to a vector clock (2, 0, 0) and a third sub region corresponding to a vector clock (3, 0, 0).

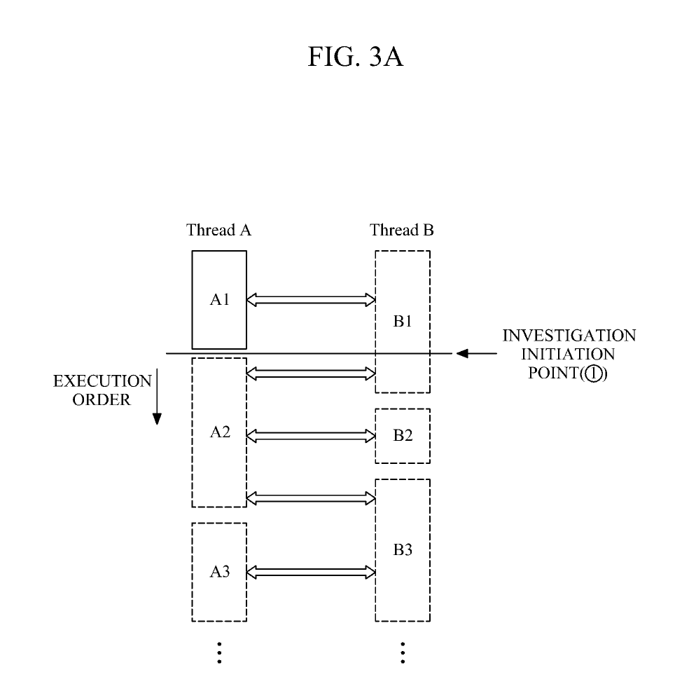

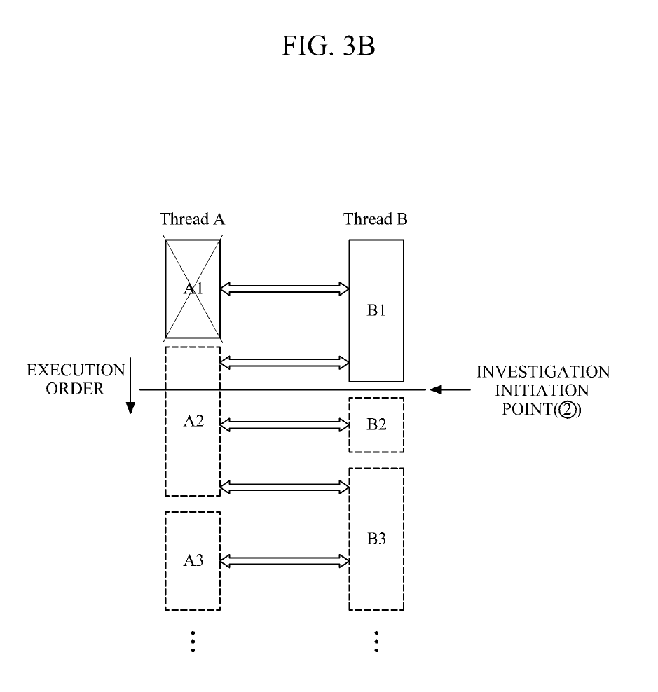

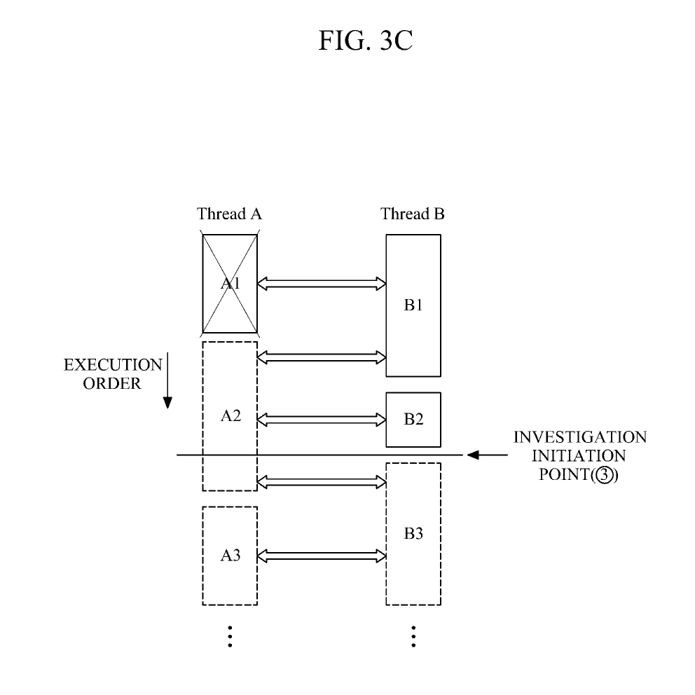

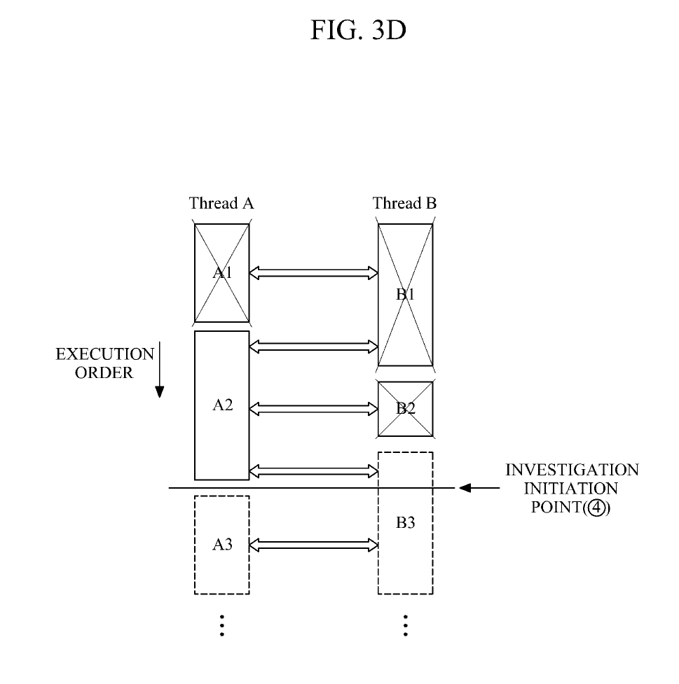

FIGS. 3A to 3D show operations of the data race detecting apparatus 100 of FIG. 1.

As shown in FIGS. 3A to 3D and in conjunction with FIG. 1, the data race detecting apparatus 100 may be applied to a multi core system concurrently executing Thread A and Thread B. The data race detecting apparatus 100 receives memory access events from Thread A and Thread B and investigates the received memory access events to detect the data race between Thread A and Thread B.

As shown each of Thread A and Thread B may be divided into one or more sub regions based on a vector clock. For example, Thread A may be divided into sub region A1, sub region A2 and sub region A3, and Thread B may be divided into sub region B1, sub region B2 and sub region B3. In addition, each sub region may be classified as a closed sub region or an open sub region according to an execution state, for example. As shown in FIGS. 3A to 3D, the closed sub region having been subject to the execution is represented by a solid line and the open sub region not having been execution is represented by a dotted line.

Accordingly, the investigation of a memory access event for data race detection may be initiated when a predetermined open sub region is converted into a closed sub region. The investigation object may be memory access events of all sub regions that have a closed state before the initiation of the investigation. A memory access event corresponding to a closed sub region having no parallel relationship with any open sub region among the investigation objects may be deleted. In FIGS. 3A to 3D, double-headed arrows represents a parallel relationship among Thread A and Thread B.

In FIG. 3A, as the execution of sub region A1 of Thread A is completed, sub region A1, which has been in an open state, is converted into closed sub region A1. At this time, the investigation of a memory access event for data race detection may be initiated. The investigation object may include sub regions that have a closed state before the investigation is initiated. For example, the memory access event of sub region A1 is an investigation object to be subject to investigation. After the investigation is completed, a closed sub region having no relationship with any other open sub region is selected among the closed sub regions having been subject to investigation, and the memory access event of the selected closed sub region is deleted. For example, sub region A1, which is one of the investigation objects, is in a parallel relationship with open sub region B1, and thus the memory access event of sub region A1 is not deleted.

In FIG. 3B, as the execution of sub region B1 of Thread B is completed, sub region B1, which has been in an open state, is converted into closed sub region B1. At this time, the investigation of a memory access event for data race detection for data race detection is initiated. The investigation object may be all sub regions that have a closed state before the investigation is initiated. For example, the memory access event of sub region A1 and the memory access event of sub region B1 are investigation objects to be subject to investigation. After the investigation is completed, a closed sub region having no relationship with any other open sub region is selected among the closed sub regions having been subject to investigation and the memory access event of the selected closed sub region is deleted. For example, of sub region A1 and sub region B1, sub region B1 is in a parallel relationship with open sub region A2 and sub region A1 has no parallel relationship with any of the open sub regions. Accordingly, the memory access event of sub region A1 is deleted.

In FIG. 3C, as the execution of sub region B2 of Thread B is completed, sub region B2, which has been in an open state, is converted into closed sub region B2. At this time, the investigation of a memory access event for data race detection may be initiated. The investigation object may be all sub regions that have a closed state before the investigation is initiated. For example, the memory access event of sub region B1 and the memory access event of sub region B2 are investigation objects to be subject to investigation. The memory access event of sub region A1 has been deleted in the above process shown in FIG. 3B, and is excluded from the investigation objects. After the investigation is completed, a closed sub region having no relationship with any other open sub region is selected among the closed sub regions having been subject to the investigation and the memory access event of the selected closed sub region is deleted. For example, of sub region B1 and sub region B2, sub region B2 is in a parallel relationship with open sub region A2 and sub region B1 is also in a parallel relationship with open sub region A2. Accordingly, the memory access events of sub regions B1 and B2 are deleted.

In FIG. 3D, as the execution of sub region A2 of Thread A is completed, sub region A2, which has been in an open state, is converted into closed sub region A2. At this time, the investigation of a memory access event for data race detection may be initiated. The investigation object may be all sub regions that have a closed state before the investigation is initiated. For example, the memory access event of sub region A2, the memory access event of sub region B1 and the memory access event of sub region B2 may be subject to investigation. The memory access event of sub region A1 has been deleted in the above process shown in FIG. 3B, and is excluded from the investigation objects. After the investigation is completed, a closed sub region having no relationship with any other open sub region is selected among the closed sub regions having been subject to the investigation and the memory access event of the selected closed sub region is deleted. For example, among sub regions A2, B1 and B2, sub region A2 is in a parallel relationship with open sub region B3, and sub regions B1 and B2 have no parallel relationship with any of the open sub regions. Accordingly, the memory access events of sub regions B1 and B2 are deleted.

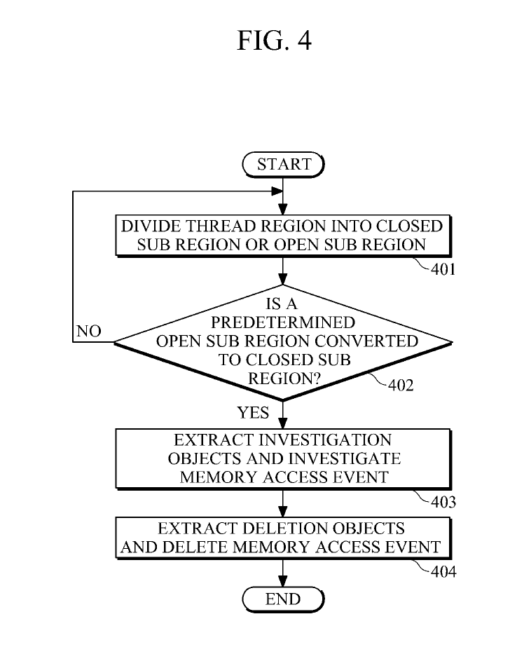

FIG. 4 shows a method of detecting data race using the data race detecting apparatus 100 of FIG. 1.

In operation 401, the thread region may be continuously classified as a closed sub region or an open region. For example, the dividing unit 101 may be configured to divide the thread regions into one or more sub regions based on the vector clock and the execution state.

In operation 402, it is determined whether a predetermined open sub region is converted into a closed sub region. For example, the investigation unit 102 may determine whether a sub region having subject to execution exists. If the result of the determination operation 402 is YES, then the processing proceeds to operation 403. Otherwise, if the result of the determination operation 402 is NO the processing returns to operation 401.

In operation 403, if a predetermined sub region is converted into a closed sub region, a memory access event for data race detection is investigated. For example, the investigation unit 102 may extract memory access events corresponding to sub regions that have a closed stage before the initiation of the investigation as investigation objects and investigates the extracted memory access events.

In operation 404, after the investigation of the memory access events are completed, a memory access event having no need for retention is deleted. For example, the deleting unit 103 may extract a deletion object from the investigation object and deletes the extracted deletion object. The deletion object may be a memory access event corresponding to a closed sub region having no parallel relationship with any open sub regions.

As described above, a data race may be detected while a thread is being executed and a memory access event used for data race detection is deleted if necessary, thereby reducing the memory use and detecting the data race in an early stage.

It will be appreciated that one or more embodiments disclosed herein may be implemented as hardware, software, computer readable codes (i.e., instructions) on a computer readable recording medium, or a combination thereof. The computer readable recording medium may be any data storage device configured to store data which can be thereafter read by a computer and/or other computing system. Examples of the computer readable recording medium may include read-only memory (ROM), random-access memory (RAM), CD-ROMs, magnetic tapes, floppy disks, optical data storage devices, and/or the like, for instance. The computer readable codes and instructions can also be distributed over network coupled computer systems so that the computer readable code is stored and executed in a distributed fashion in some implementations.

Also, functional programs, codes, and/or code segments can be easily construed by programmers skilled in the art. A number of embodiments have been described above. Nevertheless, it will be understood that various modifications may be made. For example, suitable results may be achieved if the described techniques are performed in a different order and/or if components in a described system, architecture, device, hardware, or circuit are combined in a different manner and/or replaced or supplemented by other components or their equivalents. Accordingly, other implementations are within the scope of the following claims.

What is claimed is:

1. An apparatus for detecting a data race in a computing system comprising:
a dividing unit configured to divide a thread into at least one sub region according to a vector clock;
an investigation unit configured to investigate memory access events that correspond to the at least one sub region, respectively, to detect a data race before an execution of the thread is terminated; and
a deleting unit configured to delete a memory access event having no need for retention among the memory access events having been subject to the investigation.

2. The apparatus of claim 1, wherein the at least one sub region includes a closed sub region having been subject to execution and an open region not having been execution.

3. The apparatus of claim 2, wherein the investigation unit is configured to initiate the investigation when a predetermined open sub region is converted into a closed sub region.

4. The apparatus of claim 2, wherein the investigation unit is configured to investigate the memory access event corresponding to the closed sub region.

5. The apparatus of claim 2, wherein the deleting unit is configured to delete a memory access event corresponding to the closed sub region having no parallel relationship with the open sub region among the memory access events having been subject to the investigation.

6. A method of detecting a data race in a computing system comprising:
dividing a thread into at least one sub region according to a vector clock;
investigating memory access events that correspond to the at least one sub region, respectively, to detect a data race before an execution of the thread is terminated; and
deleting a memory access event having no need for retention among the memory access events having been subject to the investigation.

7. The method of claim 6, wherein the at least one sub region includes a closed sub region having been subject to execution and an open region not having been execution.

8. The method of claim 7, wherein the investigating of memory access events is initiated when a predetermined open sub region is converted into a closed sub region.

9. The method of claim 7, wherein, in the investigating of memory access events, the memory access event corresponding to the closed sub region is investigated.

10. The method of claim 7, wherein, in the deleting of the memory access event, a memory access event corresponding to the closed sub region having no parallel relationship with the open sub region is deleted among the memory access events having been subject to the investigation.

11. A computer-readable medium having computer-executable instructions configured to execute a method of detecting a data race in a computing system, the instructions configured to:
divide a thread into at least one sub region according to a vector clock;
investigate memory access events that correspond to the at least one sub region, respectively, to detect a data race before an execution of the thread is terminated; and
delete a memory access event having no need for retention among the memory access events having been subject to the investigation.

12. The computer-readable medium of claim 11, wherein the at least one sub region includes a closed sub region having been subject to execution and an open region not having been execution.

13. The computer-readable medium of claim 12, wherein in investigating of memory access events is initiated when a predetermined open sub region is converted into a closed sub region.

14. The computer-readable medium of claim 12, wherein, in investigating of memory access events, the memory access event corresponding to the closed sub region is investigated.

15. The computer-readable medium of claim 12, wherein, in deleting of the memory access event, a memory access event corresponding to the closed sub region having no parallel relationship with the open sub region is deleted among the memory access events having been subject to the investigation.
